(19) United States
(12) Patent Application Publication
(10) Pub. No.: US 2004/0145814 A1
(43) Pub. Date: Jul. 29, 2004

(54) Optical device using a polarizing beam splitter

(76) Inventor: Philip J Rogers, Denbighshire (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/476,429

(22) PCT Filed: May 27, 2002
(86) PCT No.: PCT/GB02/02469

(30) Foreign Application Priority Data
May 26, 2001 (GB) 0112871.9

(51) Int. Cl. G02B 27/14

(52) U.S. Cl. 359/634

(57) ABSTRACT

An optical device adapted for handling plane polarised light comprising a beamsplitter cube formed of two prisms having a polarising beamsplitter (PBS) arrangement located between the hypoteneuse faces of the prisms, the cube having a first pair of opposing faces forming an illumination input face and an illumination output face, and a second pair of opposing faces at which reflection means are located, wherein image-forming light is output from the output face, the image being derived from a display source located at one of the other faces of the cube and the arrangement of the reflection means being such that the cube does not support an intermediate image of the display source.

The present invention relates to an optical device and to an illumination and/or collimation system incorporating the optical device for use in a stacked, multiple image display system. In particular the present invention relates to an optical device using a polarising beamsplitter.

Optical viewing systems, in lightweight monocular nightsights that employ non-inverting image intensifier tubes are typically constructed in a manner which requires image inversion to occur within the viewing optics of the system. Unfortunately viewing optics employing conventional means of inversion, such as refracting relay optics, are relatively bulky and heavy. In order to overcome these drawbacks an optical device using a polarising beamsplitter [“Compact Viewing Optics Using Polarisation”, P J Rogers, SPIE Vol. 655 pp 322-327, 1986] was developed. This device is shown in FIG. 1. The optical device 1 receives an image in the form of unpolarised light from a phosphor, polarises the light via a plane polariser 6 and thereafter uses a beamsplitter cube 2 to effect three passes of a polarisation selective coating 10 in the beamsplitter cube 2. A concave mirror 4 which functions as an inverting relay forms an intermediate image on a planar dichroic mirror forming part of a quarter wave plate. The concave mirror 4, having the same sign of optical power but the opposite sign of image curvature to the other optics (e.g. the eyepiece) in the system, is situated as part of a quarter wave plate. on one side of the beamsplitter cube 2 whilst the dichroic mirror and quarter wave plate is situated on the opposite side of the cube. This arrangement provides a compact “in line” (i.e. co-axial optical axis either side of the beam splitter coating 10).

In the development of modern. display systems, display devices have been devised having laser-based illumination and display sources which are inherently linearly polarised in operation. In efforts to integrate and compact the illumination and collimation systems, an optical system incorporating a polarising beamsplitter has been proposed. Ideally telecentric optics should be employed when using such optical systems, telecentric optics being lens systems where the centres of the light beams to or from all parts of the image and/or object are parallel to the optical axis, thus minimising the range of angles on the polarisation selective coating. However in general telecentric optics are difficult to design due to the undesirable positioning of the aperture stop and, in particular, the problem with obtaining a flat image. The positioning of the aperture stop renders principal rays parallel to the optical axis so that they intersect the optics at relatively large heights above the optical axis in comparison with the intersection heights of rays that define the on-axis aperture beam. This makes it difficult to correct for off-beam aberrations. In order to achieve a flat image the all-refracting optic requires high optical powers of both signs to compensate each other, however because of the relatively large heights of the principal ray this results in high off-axis aberrations.

An object of the present invention is to obviate or mitigate at least one of the aforementioned problems.

According to a first aspect of the present invention there is provided an optical device adapted for handling plane polarised light comprising a beamsplitter cube formed of two prisms having a polarising beamsplitter (PBS) arrangement located between the hypoteneuse faces of the prisms, the cube having a first pair of opposing faces forming an illumination input face and an illumination output face, and a second pair of opposing faces at which reflection means are located,

wherein image-forming light is output from the output face, the image being derived from a display source located at one of the other faces of the cube and the arrangement of the reflection means being such that the cube does not support an intermediate image of the display source.

Preferably the polarising beamsplitting arrangement comprises a PBS coating disposed on the hypotenuse face of each prism thus providing two parallel layers of PBS coating within the optical body.

Alternatively the PBS arrangement comprises a linear polariser wherein a PBS coating is disposed at each planar interface created by the linear polariser being positioned between the hypotenuse face of each prism within the optical body.

Preferably the input face of the optical device is convex and the output face of the optical device is planar.

In one embodiment the display source is adapted to emit plane polarised light and is located at the input face. In another embodiment the display source is reflective and forms one of the reflective means, and an illumination source adapted to emit plane-polarised light is located at the input face.

Conveniently a quarter wave plate is disposed between the optical body or cube and the reflection means.

Conveniently a collimator is located at said output face. The collimator is preferably telecentric. The collimator may be formed by one or more lenses and/or by diffractive optics.

Preferably the illumination source used in the another embodiment is adapted to issue telecentric illumination on the input face of the cube. The illumination source may comprise a plurality of lenses to form a desired numerical aperture of illumination incident on the input face.

The optical system is an in-line optical system which facilitates stacking of multiple units. Preferably a plurality of the optical systems may be stacked to form an array of optical systems.

Conveniently stray light baffles may be provided at each component of each optical system in the stack.

These and other aspects of the invention will become apparent from the following description when taken in combination with the accompanying drawings which show:

FIG. 1—a compact optical device using a polarising beamsplitter (PBS) coating as is known in the art;

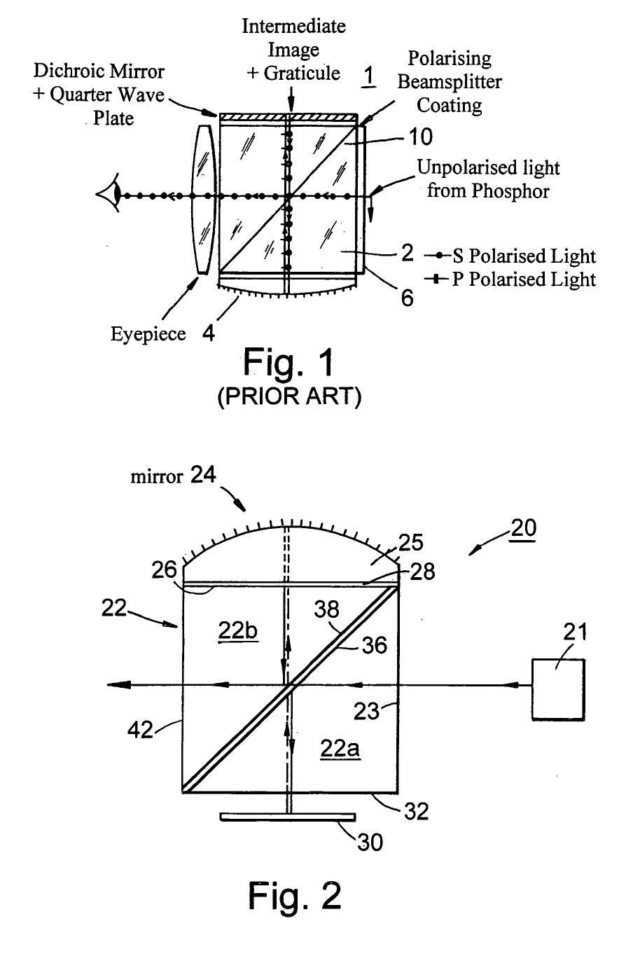

FIG. 2—a schematic representation of an optical polarising device according to a first aspect of the present invention and incorporating a reflective display source;

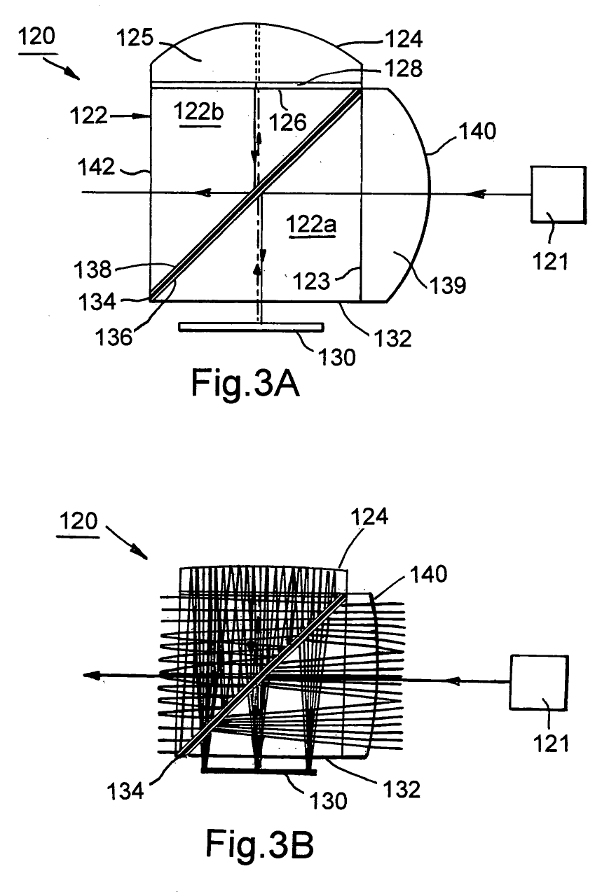

FIG. 3a—a schematic representation of a polarising optical device according to the preferred embodiment of the present invention;

FIG. 3b—the polarising optical device of FIG. 3a with telecentric illumination;

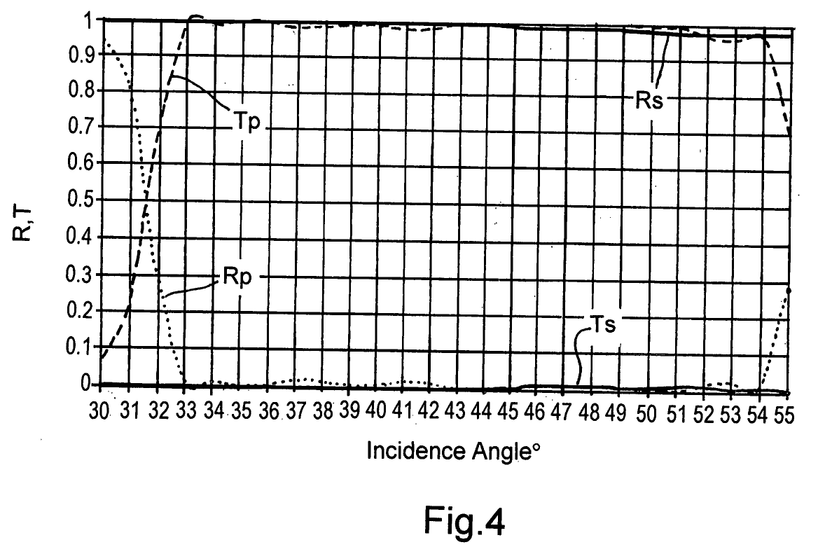

FIG. 4—a graphical representation of the characteristics of the preferred PBS coating used in the device of the present invention;

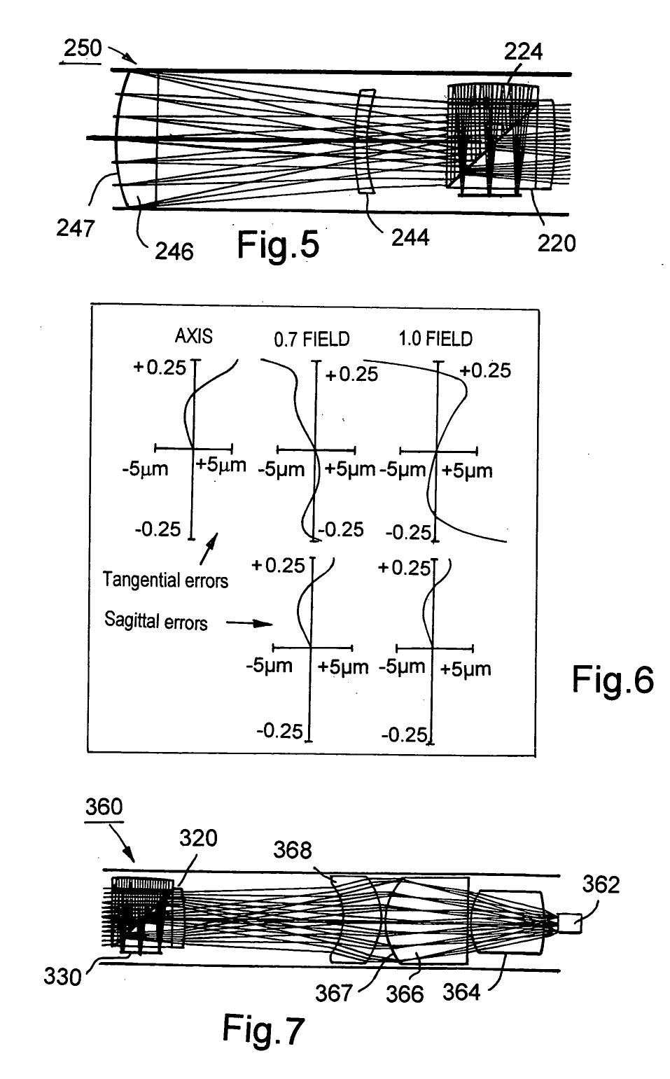

FIG. 5—a telecentric collimator incorporating the device of the present invention;

FIG. 6—a representation of the transverse aberrations at the output of the collimator of FIG. 5;

FIG. 7—a schematic representation of a dual telecentric illumination optics arrangement incorporating the device of the present invention;

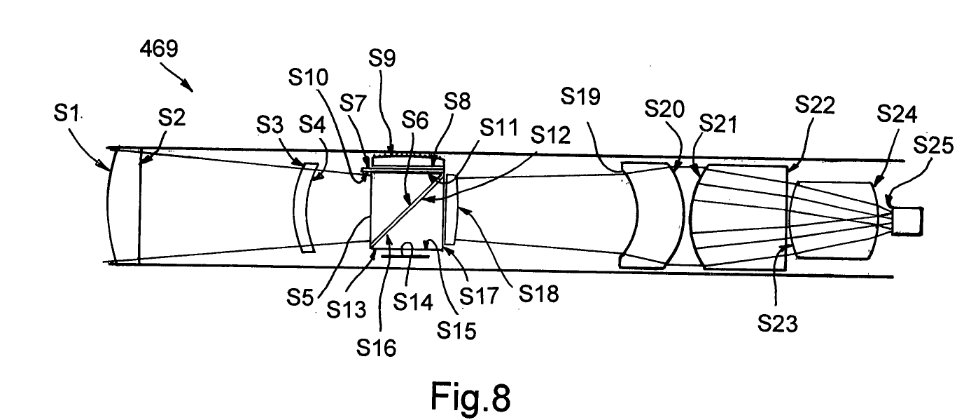

FIG. 8—a complete optical system integrating the collimator and illumination systems of FIGS. 5 and 7 for use with the data of Table 1 herein;

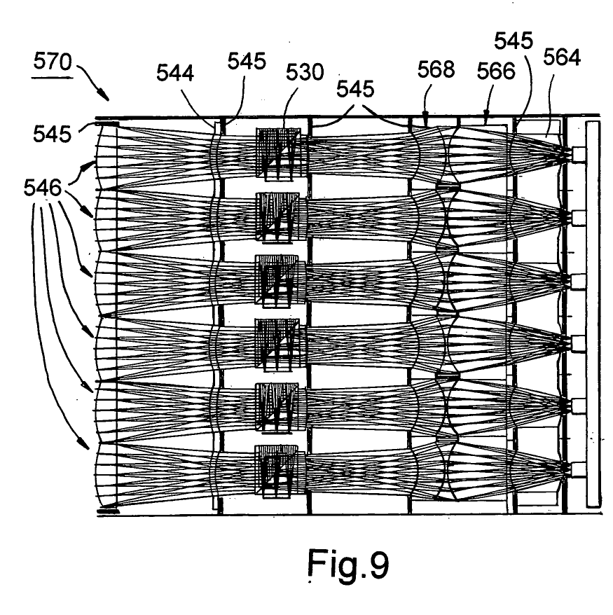

FIG. 9—a stacked array of optical systems of FIG. 8;

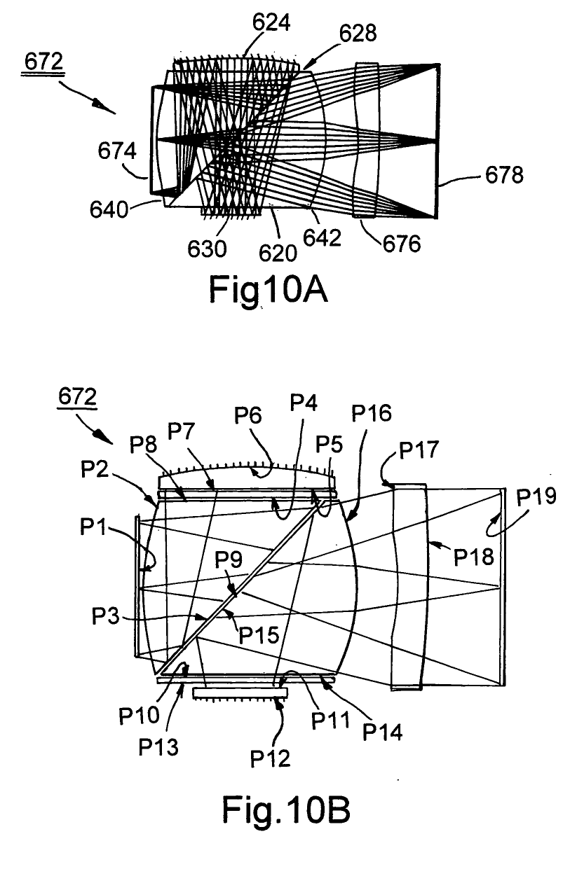

FIG. 10A—a schematic representation of an optical polarising device according to the present invention and incorporating a projection display source and showing light ray paths therein;

FIG. 10B—the device of FIG. 10A for use with the data of Table 2 herein;

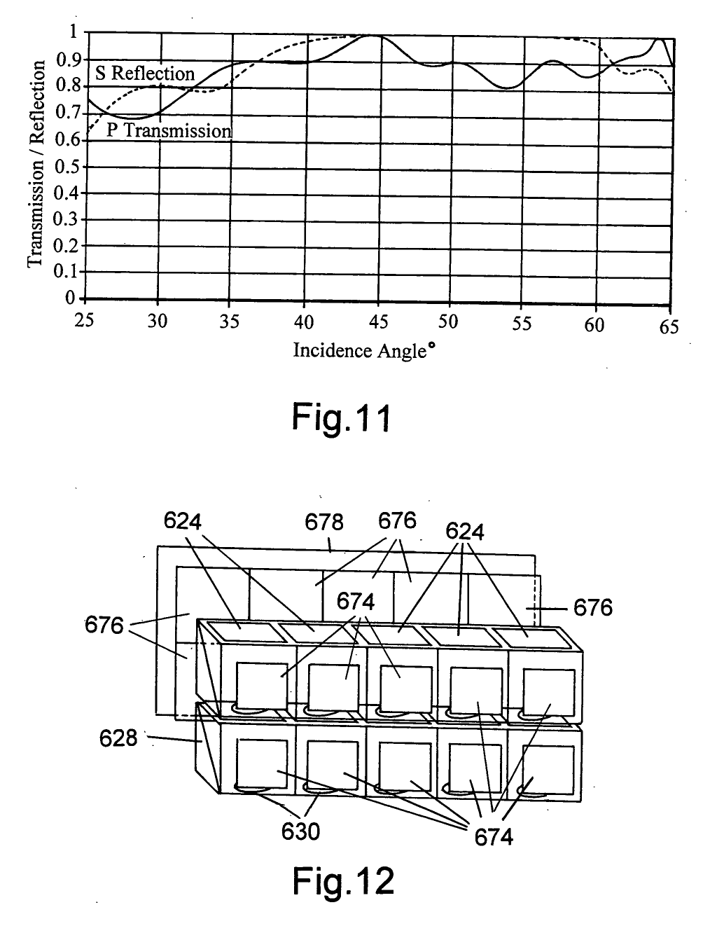

FIG. 11—PBS coating characteristics for use in the FIG. 10 device;

FIG. 12—an array of devices of FIG. 10 providing a tiled display;

With reference to FIG. 2 an optical device 20 comprises a cube body 22 formed of two prisms 22a and 22b having a polarising beamsplitter arrangement located between the hypoteneuse faces of the prisms. A mirror 24 preferably formed as part of a solid optical body 25, and preferably concave, is positioned adjacent to face 26 of the body 22 with a quarter wave plate 28 disposed between said face 26 and mirror 24. A planar display source 30 in the form of a reflective LCD (Liquid Crystal Display) is disposed at face 32 of the body 22 which is opposite to face 26. The hypotenuse face of each prism 22a and 22b is coated with a polarising beamsplitter (PBS) coating 36 and 38 respectively. The illumination output face 42 of the body is preferably planar.

Light which is inherently linearly polarised from an illumination source 21, is incident on illumination input face 23 of prism 22a to illuminate the display source 30. Upon transmission through the block 22 and after reflection from mirror 24 forming part of a collimation system a flat image of the display source 30 is formed at infinity without any intermediate image being formed before light exits from the body 22 at output face 42.

For the purpose of clarity FIG. 2 shows a single ray of light being transmitted through the device with continuous lines representing S polarised light, broken lines representing P polarised light and dotted lines representing circularly polarised light. Thus, S polarised light emitted by illumination source 21 (linearly polarised light is emitted when source 21 is a laser) is transmitted into body 22 via face 23. The light is efficiently reflected at PBS coating 36 to display source 30. At the display source 30 the light is specularly reflected and has its polarisation changed to P polarised and becomes image forming. The light ray is then transmitted efficiently by both PBS coatings 36 and 38, is transmitted through quarter wave plate 28, becoming circularly polarised, reflects off mirror 24, and passes back through the quarter wave plate 28, thus becoming S polarised. The light ray is then reflected at the PBS coating 38 and transmitted out of the body 22 via face 42 as S polarised light.

The use of S polarised light alone as input light eliminates the possibility of any P polarised light “leaking” into the body 22 and being transmitted to output face 42 by the PBS coatings, and the provision of two PBS coatings means that any “leakage” of non-image bearing S polarised light through the first coating 36 will be further blocked by second coating 38.

With reference to FIGS. 3a and 3b there is shown an optical device 120 which is generally similar to device 20 of FIG. 2. For purposes of clarity FIG. 3a shows the path of one light ray passing through the optical device 120. FIG. 3b shows the path of a plurality of light rays forming telecentric beams passing through the optical device 120. As is best shown in FIG. 3a the device 120 comprises a body 122 formed of prisms 122a and 122b of optical material having a mirror 124 preferably formed as part of a solid optical body 125, and preferably concave, positioned adjacent face 126, and quarter wave plate 128 disposed therebetween. Display source 130 in the form of a reflective LCD is disposed at face 132 of the block which is opposite face 126. A polarising beamsplitter arrangement is positioned within the optical device 120 and comprises PBS coatings 136 and 138 which are disposed on the hypotenuse faces of prisms 122a and 122b respectively and a linear polariser 134 which is sandwiched between coatings 136 and 138.

Plano-convex lens 139 is cemented to input face 123 of prism 122a to provide positive optical power close to the display source 130 in order to improve coupling and help telecentricity.

The device 120 operates in the same manner as previously described for device 20 with S polarised light transmitting into the block 122 via face 140 which is the convex face of plano-convex lens 139 formed on face 123 of prism 122a. The light reflects off PBS coating 136, travels down to display source 130 from which it is specularly reflected as P polarised image bearing light, it then is transmitted efficiently by PBS coating 136, linear polariser 134 and PBS coating 138, and goes on to transmit through quarter wave plate 128, reflects off concave mirror 124, transmits through quarter wave plate 128, reflects off PBS coating 138 and transmits out of the block 122 via face 142.

The inclusion of linear polariser 134 further reduces the leakage of S polarised light through the polarising beamsplitter arrangement.

In order for the optical device of FIGS. 2, 3a and 3b to operate with a Numerical Aperture at the output of the order of 0.25 it is important for each of the PBS coatings 36 and 38 to perform efficiently over a wide range of incidence angles; for example by the use of an advanced PBS coating, the characteristics of which (e.g. coating 38) are shown in FIG. 4, when used with prisms 22a and 22b formed of a material of high refractive index. As can be seen the PBS coating transmits very little S polarised light, represented by Ts, thus reflecting almost all S polarised light, represented by Rs, over the angle of incidence range of 30-50 degrees. Light which is P polarised will be substantially all transmitted, represented by Tp, by the coating between the angles of incidence from 33-54 degrees with very little being reflected, this being represented by Rp. However, between the ranges of 30-33 degrees and 54-55 degrees not all P polarised light is transmitted with some being reflected.

Of course, if significantly smaller input (i.e. illumination) and output Numerical Apertures are required then a less advanced form of PBS coating can be tolerated, namely a coating which performs efficiently as regards transmission and reflection only over a comparatively narrow range of incidence angles.

The optical devices 20, 120 may be utilised in various optical systems; for example, as can be seen in FIG. 5 the device may be used in a telecentric collimator system 250. This system 250 comprises optical device 220 (being identical to device 120), a first aspheric lens 244 which is a negative lens formed of an optical plastic material and a second aspheric lens 246 which is a positive lens, formed of optical plastic material and which acts as the collimator lens. The lenses 244 and 246 in conjunction with concave mirror 224 (being identical to mirror 124) act upon the image containing light beam (the source of the light beam is not shown) in a manner which provides an effective telecentric collimator system. The aperture stop of the system is at the output face 247 of lens 246. Using an arrangement wherein the collimator lens has a focal length of F=95.5 mm, an aperture of F/2, measured across the diagonal of the aperture at lens face 247 or F/2.83 across the height and width of the aperture is achieved. It may be convenient to use a collimator of much lower aperture (smaller numerical aperture) in some situations.

The telecentric collimator system 250 performs effectively, but some transverse aberrations still occur. The transverse aberrations represented by tangential error and sagittal error curves for the above system 250 when providing an aperture of F/2 are shown in FIG. 6. The representations of the errors at on axis, and at 0.7 and 1.0 field coverage of the display. The vertical axis for each curve represents the numerical aperture of the lens 246 and the horizontal axis is an image error scale. Thus, for each curve the NA is ±0.25 maximum and the image error is ±5 μm maximum.

The optical device 120 may also be used in an illumination optics system 360 such as that shown by way of example in FIG. 7. The system 360 is a dual telecentric illumination optics system having a telecentric illumination source 362, typically with a numerical aperture of 0.64, a first aspheric lens 364 formed of an optical plastic material, a second aspheric lens 366 formed of an optical plastic material the output face 367 of which provides a telecentric stop (which in this case is a square aperture stop), and a third aspheric lens 368 formed of an optical plastic material which delivers telecentric illumination to optical device 320 (which is identical to device 120).

The illumination source 362 typically incorporates a laser beam having a gaussian profile so that a similar light intensity profile would appear across the object being illuminated, i.e. display source 330 (identical to source 130). As the display source is substantially specular (with a 90° rotation of plane polarisation) it is desirable for the characteristics of light illuminating the display source 330 to match the characteristics which provide the most efficient performance of the collimating optics, for example such characteristics as telecentricity and being of the same numerical aperture. The source 362 is itself rendered telecentric with a defined numerical aperture (although this is not required) by use of a diffusion screen at the laser output.

A complete optical system 469, as shown in FIG. 8, integrating the collimating system of FIG. 5 and the illumination system of FIG. 7 may be provided. An example of construction data parameters is given in Table 1 with the surfaces numbered S1 to S25 which the light beam encounters in reverse consecutive order. By choosing the parameters of the system to avoid overfill of the numerical aperture any decreased image contrast due to illumination light incident on the PBS coatings being at an incidence angle beyond the effective range would be reduced. The collimated image-forming light delivered by the FIG. 8 system may be used for many purposes.

A plurality of the optical systems of FIG. 8 may be stacked together to form a multiple image optical array 570 as is shown in FIG. 9. In order to increase compactness of the array 570 the individual output collimating lenses 546 may be formed as an array in a single unit which may be made of plastic.

Each of the other plastic lenses 544, 564, 566 and 568 may similarly be formed as an array in a single unit with stray light baffles 545 provided to prevent cross talk or interference between each optical system in the array. However the use of telecentric aperture stops in the illumination and collimation areas of the array 570 will to a large extent prevent cross talk even if no baffles are employed because each optical system 469 generates telecentric beams of a precisely defined nature.

A modified form of the optical device according to the present invention may be utilised with an emitting LCD display source 674 as shown in FIGS. 10A and 10B. Since the display source is emitting there is no illumination source. This display system 672 comprises emitting LCD display source 674 (which is inherently telecentric and linearly polarised) adjacent the input face 640 of optical device 620, a field lens 676 adjacent the output face 642 of the optical device 620, and an image display means 678. Device 620 incorporates a polarising beamsplitter arrangement 628. The input face 640 and output face 642 of the optical device 620 are, in this case, convexly curved. Additionally the first mirror 624 and the second mirror 630 of the optical device are concave mirrors each incorporating a quarter wave plate, the second mirror 630 also acting as a telecentric aperture stop for the input beam. The LCD 674 emits plane polarised light over a polar angle of around ±12° or so centred on a normal. As display system 672 is compactly formed, any magnification which is required has to be achieved in a very short distance, and this requires a high level of optical power in terms of both reflection and refraction for a flat image to be provided on display means 678. The aspheric field lens 676 removes any residual distortion or high order field curvature. However a greater field angle tolerance is required from the optical device 720 than for devices 20, 120, etc due to the relatively large aspect ratio, i.e. about 0.7, between the display diagonal size and display source to final image distance. This ratio is necessary to give a display workstation of small front-to-back dimension. This large field angle gives rise to a greater range of input light beam incidence angles at the PBS coating. To accommodate the range of incidence angles use is made of a less advanced PBS coating but one which provides reasonable discrimination between S and P polarised light. The performance of this coating is shown in FIG. 11. In using such a PBS coating it is desirable for the PBS arrangement 628 to comprise a linear polariser having a PBS coating disposed on each surface to ensure the prevention of leakage of S polarised light through the optical device. Construction data parameters are given in Table 2 for the display system of FIG. 10B with each surface numbered P1 to P19.

The aspheric lens 676 of FIG. 10A may be formed of plastic and can be formed as part of a continuous array for stacking purposes. Such a stacked arrangement is shown in FIG. 12. Display systems such as these are very useful when it is not possible to “tile” a number of display sources, such as LCD's, by butting the active areas of each source together.

It will be understood that various modifications may be made to the optical device and its associated arrangements without departing from the scope of the invention. For example, the optical device may comprise a PBS arrangement wherein the PBS coating reflects P polarised light and transmits S polarised light if the illumination source or display source emits P polarised light. In the complete optical system parameters and optical materials could be altered to change the performance of the system, i.e. a device having lower refractive index could be used, for example, where the system is of low numerical aperture. The lenses of the preferred system are aspheric to achieve compactness, however a spherically-surfaced system of lenses could be used. As regards the system of FIG. 8 although the illumination source is a laser beam having a gaussian profile this may be converted into a top-hat profile by using two separated lenses of extreme aspheric shape which act as a laser beam expander. Polarisation purity of the laser beam input light beam needs to be maintained but its coherence length may be shortened. This may be done by positioning a rotating high gain diffuser in the laser beam expanding region and would reduce speckle and interference effects. Another modification may be to use a diffusion screen of an appropriate numerical aperture which is illuminated by a laser beam which may have been expanded. This would allow the collection of telecentric light of a given numerical aperture from the illumination source.

The beam expanding optics may be used marginally to converge or diverge the light beam as required for each particular use so that strict telecentricity may not be required in each case.

The body of the optical device may be made of glass, or alternatively of an optical plastic such as acrylic, or a commercial plastic such as Zeonex, CR39 and various other high refractive index opthalmic plastics, which provide adequate transmission over the long path length through the cube. For some, but not all, uses the surfaces of the cube body need not be of high accuracy and could therefore, if made of glass, be fire polished or if made of plastic could be moulded. If the device is formed of plastic optical materials it is possible that the material of the mirrors could be made birefringent in order to provide the correct level of phase retardation, this would remove the need for quarter wave plates within the optical device.

If the device is formed of glass a separate positively powered lens may be positioned near the display source of the projected display system (FIG. 10) to allow the size of the body of the optical device to be reduced if the mass is deemed too high.

Another modification in display systems may be the use of digital micro mirror devices or the like as the display source.

TABLE 1
Construction Data for the Collimator + Illumination System

| Surface | | | Thickness | | Refractive | | | |
|---|---|---|---|---|---|---|---|---|
| Number | Component | Radius | Separation | Diameter | Index | E | A4 | A6 |
| S1* | Lens | 51.912vex | 10.000 | 47.8(2) | 1.49527 | 0.63391 | −5.22E−08 | −2.23E−11 |
| S2 | | Plano | 47.835 | 47.8 | 1 | | | |
| S3* | Lens | 46.974vex | 3.000 | 32.4 | 1.49527 | 0.74724 | −2.01E−06 | −2.14E−09 |
| S4 | | 35.649cav | 19.759 | 30.9 | 1 | | | |
| S5 | Prism Face | Plano | 11.000 | 28.6 | 1.81997 | | | |
| S6 | PBS Coating(R) | Plano | −11.000 | 37.9(3) | −1.81997 | | | |
| S7 | 1/4 Wave Plate(5) | Plano | −0.200 | 26.9 | −1.81997 | | | |
| S8 | Mirror (in) | Plano | −3.313 | 26.9 | −1.81997 | | | |
| S9 | Mirror (out) | 288.085ca | 3.313 | 26.7 | 1.81997 | | | |
| S10 | 1/4 Wave Plate(5) | Plano | 0.200 | 25.9 | 1.81997 | | | |
| S11 | Prism Face | Plano | 11.000 | 25.9 | 1.81997 | | | |
| S12 | PBS Coating(T) | Plano | 11.000 | 32.4(3) | 1.81997 | | | |
| S13 | Prism Face | Plano | 1.752 | 20.1 | 1 | | | |
| S14 | Display | | −1.752 | 19.3 | −1 | | | |
| S15 | Prism Face | Plano | −11.000 | 20.2 | −1.81997 | | | |
| S16 | PBS Coating(R) | Plano | 11.000 | 37.9(3) | 1.81997 | | | |
| S17 | Prism Face | Plano | 4.500 | 26.2 | 1.81997 | | | |
| S18 | Lens | 59.798vex | 57.055 | 26.9 | 1 | | | |
| S19 | Lens | 20.636cav | 13.891 | 33.0 | 1.49527 | | | |
| S20* | | 24.641vex | 1.000 | 41.9 | 1 | 0.43069 | −7.92E−06 | −9.54E−10 |
| S21* | Lens | 21.093vex | 30.128 | 46.2 | 1.49527 | 0.60028 | −5.17E−06 | −2.50E−09 |
| S22* | | 35.534cav | 1.000 | 35.0 | 1 | −26.522 | −4.68E−05 | 8.07E−08 |
| S23* | Lens | 15.161vex | 26.432 | 30.3 | 1.49527 | −0.88609 | −6.49E−05 | 1.42E−08 |
| S24 | | 40.737vex | 4.925 | 15.5 | | | | |
| S25 | Laser Source | | | 7.6 | | | | |

Notes:
(1) System is given in reverse from actual operation
S1 to S13 is the collimator system,
(2) Front lens is square in section
S13 to S24 is the illumination system
(3) 45° Face
(4) On the PBS Coating,
(R) is reflection
(T) is transmission
(5) 1/4 Wave Plate may have a different refractive index
*Aspheric Surface. Sag X = +c.r2/(1 + (1 − E.c2.r2)½) + A4.r4 + A6.r6 where c = 1/Radius & numbers after ‘c’ & ‘r’ are exponents

TABLE 2
Construction Data for the Tiling Projector System

| Surface | | | Thickness | | Refractive | | | |
|---|---|---|---|---|---|---|---|---|
| Number | Component | Radius | Separation | Diameter | Index | E | A4 | A6 |
| P1 | LCD Display | Plano | 0.320 | 72.0 | 1 | | | |
| P2* | Convex Input Face | 59.223vex | 35.000 | 75.2 | 1.68808 | 0.61898 | −6.25E−06 | 2.22E−09 |
| P3 | PBS Coating (R) | Plano | −30.000 | 89.5(2) | −1.68808 | | | |
| P4 | 1/4 Wave Plate | Plano | −0.200 | 67.7 | −1.50722 | | | |
| P5 | Mirror (in) | Plano | −5.500 | 67.7 | −1.68808 | | | |
| P6 | Mirror (out) | 174.299cave | 5.500 | 67.4 | 1.68808 | | | |
| P7 | 1/4 Wave Plate | Plano | 0.200 | 65.3 | 1.50722 | | | |
| P8 | Prism Face | Plano | 30.000 | 65.3 | 1.68808 | | | |
| P9 | PBS Coating (T) | Plane | 29.500 | 73.6(2) | 1.68808 | | | |
| P10 | 1/4 Wave Plate | Plano | 0.200 | 25.8 | 1.50722 | | | |
| P11 | Mirror (In) | Plane | 3.000 | 25.8 | 1.68808 | | | |
| P12 | Mirror (out) | 354.307cave | −3.000 | 28.1 | −1.68808 | | | |
| P13 | 1/4 Wave Plate | Plano | −0.200 | 30.2 | −1.50722 | | | |
| P14 | Prism Face | Plano | −29.500 | 30.2 | −1.68808 | | | |
| P15 | PBS Coating (R) | Plano | 43.000 | 94.3(2) | 1.68808 | | | |
| P16* | Convex Output Face | 40.115vex | 14.575 | 78.7 | 1 | −4.4664 | 8.72E−07 | −3.94E−10 |
| P17* | Lens | 43.112cave | 10.000 | 103.0 | 1.50722 | −32.874 | 3.34E−06 | −5.98E−10 |
| P18 | | 396.451vex | 27.513 | 103.0 | 1 | | | |
| P19 | Image | Plano | | | | | | |

Notes:
(1) All surfaces are rectangular in cross section
(2) 45° Face
(3) On the PBS Coating,
(R) is reflection
(T) is transmission
*Aspheric Surface. Sag X = +c.r2/(1 + (1 − E.c2.r2)½) + A4.r4 + A6.r6 where c = 1/Radius & numbers after ‘c’ & ‘r’ are exponents

1. An optical device adapted for handling plane polarised light comprising a beamsplitter cube formed of two prisms having a polarising beamsplitter (PBS) arrangement located between the hypoteneuse faces of the prisms, the cube having a first pair of opposing faces forming an illumination input face and an illumination output face, and a second pair of opposing faces at which reflection means are located,
wherein image-forming light is output from the output face, the image being derived from a display source located at one of the other faces of the cube and the arrangement of the reflection means being such that the cube does not support an intermediate image of the display source.

2. An optical device as claimed in claim 1, wherein the PBS arrangement comprises a linear polariser interposed between two polarisation selective coating layers.

3. An optical device as claimed in claim 1 or claim 2, wherein the display source is adapted to emit plane polarised light and is located at the input face.

4. An optical device as claimed in claim 1 or claim 2, wherein the display source is reflective and forms one of the reflective means, and an illumination source adapted to issue plane polarised light is located at the input face.

5. An optical device as claimed in any preceding claim, wherein the input face of the cube is convexly profiled.

6. An optical device as claimed in any preceding claim, wherein one of the reflection means is concave.

7. An optical device as claimed in claim 6, wherein a quarter-wave plate is located between said one reflection means and the cube.

8. An optical device as claimed in any preceding claim, including a collimator located at said output face.

9. An optical device as claimed in any one of claims 4 to 8, wherein the illumination source is adapted to issue telecentric illumination incident on the input face.

10. An optical device as claimed in claim 9, wherein the illumination source comprises a laser.
